(19) United States
(12) Patent Application Publication
(10) Pub. No.: US 2010/0109427 A1
(43) Pub. Date: May 6, 2010

(54) HYDRAULIC VEHICLE BRAKE SYSTEM AND METHOD FOR ITS OPERATION

(76) Inventor: Dietmar Baumann, Hemmingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/598,521

(22) PCT Filed: Mar. 7, 2008
(86) PCT No.: PCT/EP08/52775

§ 371 Date: Nov. 2, 2009

(30) Foreign Application Priority Data
May 2, 2007 (DE) 10 2007 020 503.3

(51) Int. Cl. B60T 8/26; B60T 8/00

(52) U.S. Cl. 303/9.75; 303/6.01; 303/9.62

(57) ABSTRACT

The invention relates to a hydraulic vehicle brake system with slip control. The invention proposes that wheel brakes at wheels of a front axle are of self-amplifying design in order to provide boosting of the brake force. An otherwise conventional vacuum brake force booster can be dispensed with. The invention further relates to a method for operating a hydraulic vehicle brake system, according to which, at high lining friction values, brake fluid is conducted, in a manner controlled by a valve, into a hydraulic reservoir.

### PRIOR ART

The invention relates to a hydraulic vehicle brake system with the defining characteristics of the preamble to claim 1 and to a method for its operation, with the defining characteristics of the preamble to claim 11.

Self-amplifying hydraulic wheel brakes for motor vehicles in the form of disc brakes are known. They have essentially the same design as conventional wheel brakes (disc brakes) without self-amplification and are supplemented with a self-amplification device. They therefore have a brake piston, which, when acted on by hydraulic pressure, presses a friction brake lining against a brake disc. For the self-amplification, at least one friction brake lining can be moved parallel to the brake disc in the circumferential or chord direction of the brake disc and rests against an auxiliary piston. When the disc brake is actuated, the rotating brake disc acts on the friction brake lining, which is pressed against it, in opposition to the auxiliary piston, thus displacing brake fluid and thereby producing a hydraulic pressure that acts on the brake piston or an additional piston that also presses the friction brake lining against the brake disc. The clamping force, i.e. the pressing force with which the friction brake lining is pressed against the brake disc is thus increased, giving the disc brake a self-amplifying action. To achieve a self-amplification for both rotation directions of the brake disc, auxiliary pistons can be provided at both ends of the friction brake lining. This constitutes a hydraulic self-amplification.

The published, nonexamined German patent disclosure DE 103 38 449 A1 has disclosed a vehicle brake system with electromechanical wheel brakes in which wheel brakes of wheels of a front axle have a self-amplification. Wheel brakes of wheels of a rear axle are either conventional, i.e. without self-amplification, or are self-amplifying. The wheel brakes of the known vehicle brake system are likewise embodied in the form of disc brakes. They are electromechanically actuated, they have an electric motor that presses a friction brake lining against a brake disc by means of a rotation/translation converting transmission such as a screw mechanism. Preferably, a reduction gear is connected between the electric motor and the screw mechanism. The self-amplification occurs mechanically by means of a wedge mechanism; the friction brake lining is movable in the circumference or secant direction of the brake disc and rests against a wedge surface that extends at an oblique angle to the brake disc. If the friction brake lining is movable in the circumference direction in relation to the brake disc, i.e. on an arc-shaped path, then strictly speaking, the wedge surface is helical. The wedge angle can be constant over the length of the wedge surface or it can also change. In the latter case, it is referred to as a ramp mechanism. The intensity of the self-amplification changes with the wedge angle; a wedge angle that becomes more acute over the shifting distance permits achievement of a higher self-amplification with a higher clamping- and braking force.

The principle of electromechanical wheel brakes cannot be transferred, or cannot be easily transferred, to a hydraulic vehicle brake system. One reason for this is that hydraulic wheel brakes connected to a shared brake circuit communicate with one another; their clamping forces are proportional to the piston surfaces of their braking pistons. Electromechanical wheel brakes are independent of one another; there is no interaction and in particular, a clamping- or braking force of one wheel brake does not influence the forces occurring in another wheel brake. Another reason is a wear readjustment that takes place automatically in hydraulic wheel brakes—at least if they are embodied as disc brakes. In an electromechanical wheel brake that has a self-amplification with a wedge mechanism, a wear compensation of the friction brake lining can take place in that the friction brake lining that is slid along the wedge surface to actuate the wheel brake is not slid all the way back into its starting position when the wheel brake is released. This wear compensation, however, is not automatic and also has the disadvantage that when the driving direction is reversed, the friction brake lining must first be slid out of the deflected position into the starting position before an advancing motion in relation to the brake disc can occur.

### DISCLOSURE OF THE INVENTION

The hydraulic vehicle brake system according to the invention, with the defining characteristics of claim 1 has a combination of self-amplifying hydraulic wheel brakes on wheels of one vehicle axle and hydraulic wheel brakes without self-amplification on wheels of another vehicle axle. Preferably, the wheels of the front axle of a vehicle have the self-amplifying hydraulic wheel brakes and the wheels of the rear axle have the wheel brakes without self-amplification (claim 2). In addition, the wheel brakes with the self-amplification are preferably self-amplifying in both driving directions; usually, a self-amplification is more important for driving forward than for driving in reverse and it can therefore suffice to have a self-amplifying action for the one driving direction, in particular the forward driving direction. The arrangement of self-amplifying wheel brakes on wheels of the rear axle and wheel brakes without self-amplification on wheels of the front axle or a mixed arrangement of one self-amplifying wheel brake on one wheel of a vehicle axle and one wheel brake without self-amplification on another wheel of the same vehicle axle is possible within the scope of the invention, but is less advantageous with regard to the actuating work that a driver must exert, which is why self-amplifying hydraulic wheel brakes of the wheels of the front axle are preferable.

One advantage of the invention is that the vehicle brake system is less expensive than a vehicle brake system whose wheel brakes are all self-amplifying, since self-amplifying wheel brakes—because of the greater manufacturing complexity due to the presence of the additional self-amplification device—are more expensive than conventional wheel brakes without self-amplification. If a self-amplifying wheel brake communicates with a wheel brake without self-amplification, then the self-amplification also acts on the wheel brake without self-amplification. If the self-amplifying wheel brakes are embodied with a powerful self-amplification, then all of the wheel brakes of the vehicle brake system according to the invention are able to achieve a self-amplification that corresponds to the self-amplification of a vehicle brake system whose wheel brakes are all self-amplifying, but have a less powerful self-amplification. Despite the use of wheel brakes without self-amplification, the self-amplification of the vehicle brake system according to the invention can be as powerful as the self-amplification of a vehicle brake system in which all of the wheel brakes are self-amplifying.

Another advantage of the invention is a lower actuation energy and actuation power than vehicle brake systems without self-amplification.

Advantageous embodiments and modifications of the invention disclosed in claim 1 are the subject of the dependent claims. According to claim 3, the self-amplifying wheel brakes have a different spring rate than the wheel brakes without self-amplification; preferably, the self-amplifying wheel brakes have a higher spring rate than the wheel brakes without self-amplification (claim 4). The wheel brakes of the wheels of the front axle can have the higher spring rate, which is only a difference if the self-amplifying wheel brakes are not provided on the wheels of the front axle, but instead on the wheels of the rear axle. The wheel brakes, i.e. the brake caliper and friction brake lining in a disc brake, are not absolutely rigid, but are instead deformed by the clamping force; the brake caliper is expanded and the friction brake lining is compressed. The actual advancing or clamping distance by which the brake piston is moved during an application of the brakes therefore increases. The ratio between the clamping force and the clamping distance yields the spring rate. A higher spring rate means a stiffer brake and a shorter clamping distance of the brake piston in order to produce a certain clamping force. The different spring rates of the brake calipers and the wheel brakes of the wheels of the front and rear axle, or more precisely stated, of the self-amplifying wheel brakes and the wheel brakes without self-amplification, can be used to influence a pedal force/pedal travel characteristic curve of the vehicle brake system. The goal is to approximate a characteristic curve of the kind to which a driver is accustomed in conventional hydraulic vehicle brake systems, for example with vacuum brake boosters and without self-amplifying wheel brakes. This familiar characteristic curve can be at least approximately achieved by selecting appropriate spring rates of the self-amplifying wheel brakes and of the wheel brakes without self-amplification and also by selecting an appropriate self-amplification intensity. In addition, with this embodiment of the invention, it is possible to keep the dependence of the pedal force/pedal travel characteristic curve to a minimum, particularly in the event of a change in a brake lining friction coefficient between the friction brake lining and the brake disc.

In an embodiment of the invention proposed according to claim 6, the vehicle brake system has no brake boosters, e.g. no vacuum brake boosters, and also has no separate vacuum pump. The elimination of these units is an advantage in terms of cost and space. The brake boosting is provided by the self-amplifying action of the self-amplifying wheel brakes and by the ratio of the piston areas of a master brake cylinder and the brake pistons of the wheel brakes.

The self-amplification devices of the self-amplifying wheel brakes can essentially be embodied in any form, i.e. in addition to being mechanical, they can also be hydraulic, for example. Claim 7 provides a mechanical self-amplification device with a wedge mechanism, whose meaning should also be understood to include a ramp mechanism with a wedge angle that changes over the length of the shifting distance of the friction brake lining. For a self-amplification in both driving directions, the wedge mechanism can have a counterpart wedge surface with an opposite slope.

According to claim 9, the self-amplifying friction brakes are travel-amplifying. In this instance, the movement of the friction brake lining in the circumference direction of the rotating brake disc shortens the clamping distance of the brake piston. Through a higher hydraulic force conversion ratio, i.e. a smaller piston area of the master brake cylinder in comparison to the piston areas of the brake pistons of the wheel brakes, it is possible to achieve a powerful amplifying action using travel-amplifying wheel brakes.

With the method according to the invention having the defining characteristics proposed in claim 11, at high brake lining friction coefficients, a braking pressure is reduced through the opening of valves. In particular, existing valves such as the outlet valves or brake pressure-reducing valves are opened and the brake pressure is controlled or regulated through control or regulation of the valves. This reduces the brake pressure in the wheel brake(s) or reduces the increase in brake pressure. This reduces a slope of the pedal force/pedal travel characteristic curve with the aim of keeping it approximately constant—or at any rate reducing its variation—when changes occur in the brake lining friction coefficient. The repercussions of temperature-, water-, or contamination-induced changes in brake lining friction coefficients on a brake pedal or manual brake lever decrease and a fluctuation of a brake pedal travel or manual brake lever travel required to produce a certain braking force is less than the change in brake lining friction coefficient. The method according to the invention can be carried out by means of hydraulic vehicle brake systems having self-amplifying wheel brakes or having wheel brakes without self-amplification. Preferably, the method is used with hydraulic vehicle brake systems having a combination of self-amplifying wheel brakes on one vehicle axle and wheel brakes without self-amplification on another vehicle axle (claim 12).

### BRIEF DESCRIPTION OF THE DRAWINGS

The invention will be explained in greater detail below in conjunction with an exemplary embodiment shown in the drawings.

FIG. 1 is a hydraulic circuit diagram of a vehicle brake system according to the invention; and

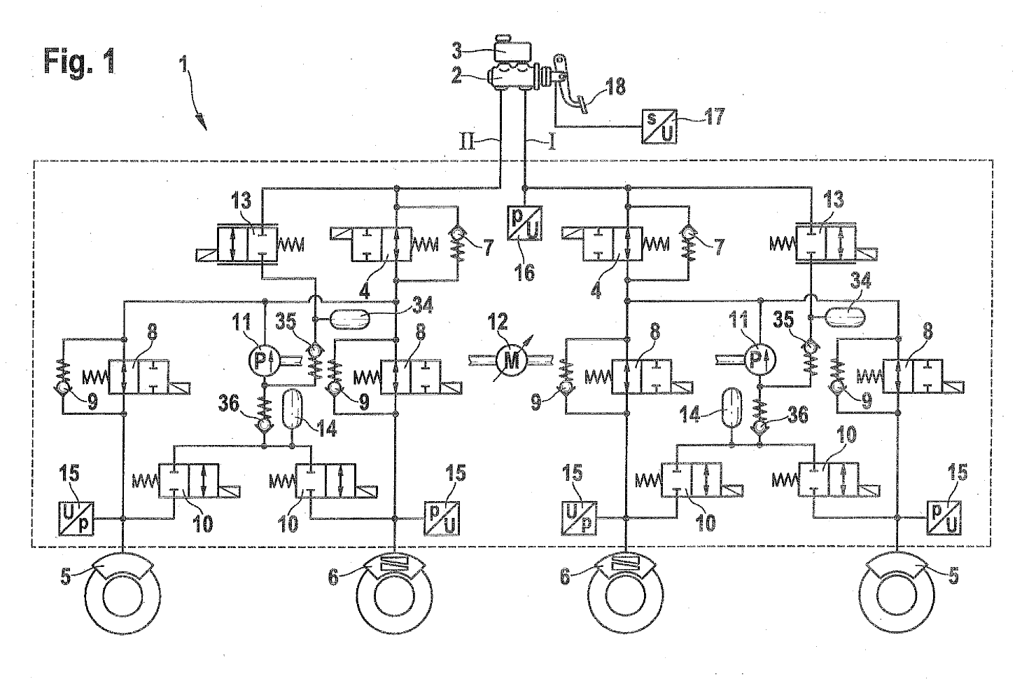

FIGS. 2 and 3 show the wheel brakes of the vehicle brake system according to the invention from FIG. 1.

### EMBODIMENT OF THE INVENTION

The hydraulic vehicle brake system 1 according to the invention shown in the drawings is equipped with wheel slip control (antilock brakes ABS; traction control system TCS; electronic stability program ESP). It is embodied in the form of a dual-circuit brake system with two brake circuits I, II that are connected to a brake master cylinder 2. The brake master cylinder 2 does not have a brake booster. The brake master cylinder 2 has a brake fluid reservoir 3 mounted on it. Each brake circuit I, II is connected to the brake master cylinder 2 via an isolating valve 4. The isolating valves 4 are 2/2-port directional control solenoid valves that are open in their currentless normal position. The isolating valves 4 are each hydraulically connected in parallel with a check valve 7 through which a flow can travel from the brake master cylinder 2 to the wheel brakes 5, 6. The isolating valves 4 of each brake circuit I, II are connected to the wheel brakes 5, 6 via brake pressure-increasing valves 8. The brake pressure-increasing valves 8 are 2/2-port directional control solenoid valves that are open in their currentless normal position. They are each hydraulically connected in parallel with a check valve 9 through which a flow can travel from the wheel brakes 5, 6 toward the brake master cylinder 2.

Each wheel brake cylinder 5, 6 is connected to a brake pressure-reducing valve 10 and these valves are jointly connected to an intake side of a hydraulic pump 11. The brake pressure-reducing valves 10 are embodied in the form of 2/2-port directional control solenoid valves that are closed in their currentless normal position. A pressure side of the hydraulic pump 11 is connected between the brake pressure-increasing valves 8 and the isolating valves 4, i.e. the pressure side of the hydraulic pump 11 is connected to the wheel brakes 5, 6 via the brake pressure-increasing valves 8 and is connected to the brake master cylinder 2 via the isolating valve 4.

Each of the two brake circuits I, II has a hydraulic pump 11 and both of these pumps can be driven by a shared electric motor 12.

The intake sides of the hydraulic pumps 11 are connected to the brake master cylinder 2 via intake valves 13. The intake valves 13 are 2/2-port directional control solenoid valves that are closed in their currentless normal position. To achieve a rapid brake pressure increase, the intake valves 13 are opened so that the hydraulic pumps 11 draw directly from the brake master cylinder 2. This is particularly important if a wheel brake pressure is to be built up by the hydraulic pumps 11 when the brake master cylinder 2 is not being actuated. With a traction control system, for example, this is the case when starting off or accelerating and with an electronic stability program, this is sometimes the case as well.

On the sides of the brake pressure-reducing valves 10 oriented away from the wheel brakes 5, 6 and therefore on the intake sides of the hydraulic pumps 11, a hydraulic reservoir 14 is connected to each brake circuit I, II. The hydraulic reservoirs 14 are used to temporarily store brake fluid that is discharged from the wheel brakes 5, 6 via the brake pressure-reducing valves 10 during wheel slip control. Additional hydraulic reservoirs 34 for accommodating brake fluid from the brake master cylinder 2 can also be provided. The additional hydraulic reservoirs 34 are connected between the intake valves 13 and the intake sides of the hydraulic pumps 11; check valves 35 through which a flow can travel toward the hydraulic pumps 11 are connected between the additional hydraulic reservoirs 34 and the hydraulic pumps 11. In this case, check valves 36 through which a flow can travel toward the hydraulic pumps 11 must also be provided between the hydraulic reservoirs 14 and the hydraulic pumps 11. By opening the intake valves 13, upon or during actuation of the brake master cylinder 2, brake fluid flows out of the brake master cylinder 2 and into the additional hydraulic reservoirs 34 that are available to the hydraulic pumps 11. As mentioned above, the additional hydraulic reservoirs 34—together with their check valves 35 and the check valves 36—are not required, but can be optionally provided.

The brake pressure-increasing valves 8 and the brake pressure-reducing valves 10 constitute wheel brake pressure modulating valve devices, which, when the hydraulic pumps 11 are being driven, can be used to achieve an individual-wheel brake pressure regulation for wheel slip control purposes in a way that is intrinsically known and need not be explained here.

During a wheel slip control, the isolating valves 4 are closed and the brake circuits I, II are thus hydraulically isolated from the brake master cylinder 2. This avoids repercussions, in particular a vibrating brake pedal or, particularly on a motorcycle, a vibrating manual brake lever, due to brake fluid pressure pulsations as a result of brake pressure modulation. In addition, the closed isolation valves 4 prevent brake fluid delivered by the hydraulic pumps 11 from flowing back into the brake master cylinder 2 when it is not being actuated. By very nature of its construction, the brake master cylinder 2 hydraulically isolates the brake fluid reservoir 3 from itself when it is actuated. This therefore prevents brake fluid delivered by the hydraulic pumps 11 from flowing back into the brake master cylinder 2 when the brake master cylinder 2 is being actuated.

Each wheel brake 5, 6 has a pressure sensor 15 connected to it. Another pressure sensor 16 is connected to the brake master cylinder 2 in one of the two brake circuits I. The brake master cylinder 2 has a pedal-travel sensor 17 that measures a pedal travel of a brake pedal 18.

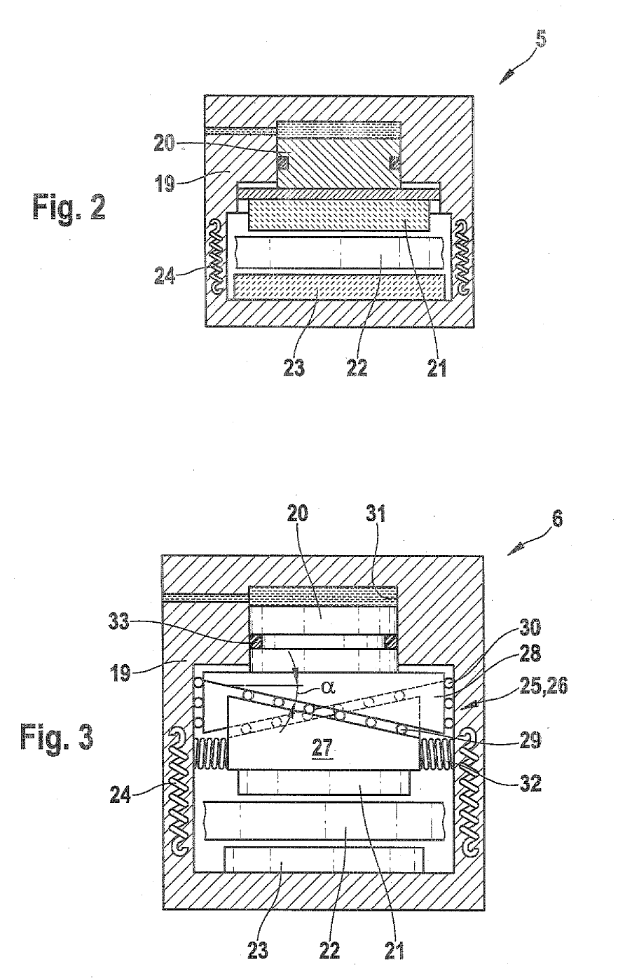

The wheel brakes 5, 6 of the vehicle brake system 1 according to the invention are hydraulic disc brakes, but the invention is not limited to disc brakes. The wheel brakes 5 mounted on wheels of a rear axle of a motor vehicle equipped with the vehicle brake system 1 are conventional hydraulic disc brakes without self-amplification, one of which is depicted in a schematic, simplified fashion in FIG. 2. The wheel brake 5, which is also referred to below as a disc brake 5, has a brake caliper 19 in which a brake piston 20 is situated, with which a friction brake lining 21 can be pressed against a brake disc 22. The brake caliper 19 is embodied in the form of a floating caliper, i.e. it is able to move transversely in relation to the brake disc 22. When the friction brake lining 21 is pressed against the one side of the brake disc 22, this shifts the brake caliper 19 transversely in relation to the brake disc 22, causing a friction brake lining 23 situated on the other side of the brake disc 22 to be pressed against the brake disc 22, thus braking the latter. This is intrinsically known and need not be explained in greater detail here. The brake caliper 19 cannot be embodied as absolutely rigid; it has an elasticity that causes it to expand because of a clamping force with which the brake piston 20 presses the friction brake linings 21, 23 against the brake disc 22 in order to brake. The elasticity of the brake caliper 19 is illustrated in FIG. 2 by means of springs 24. No such springs 24 are actually present. The elasticity of the brake caliper 19 lengthens a clamping travel of the brake piston 20 during actuation of the disc brake 5. The elasticity of the brake caliper 19 can be ascertained by means of a spring force c that indicates the ratio of the clamping force—with which the brake piston 20 presses the friction brake linings 21, 23 against the brake disc 22 during actuation of the disc brake 5—to a shifting distance or clamping travel of the brake piston 20. The spring rate c also includes an elasticity of the friction brake linings 21, 23 that are elastically compressed by the clamping force during actuation of the disc brake 5. The greater the spring rate c, the more rigid the brake caliper 19, i.e. the more slight its deflection during actuation of the disc brake 5.

The wheel brakes 6 of the wheels of the front axle are likewise disc brakes; by contrast with the wheel brakes 5 of the wheels of the rear axle, however, they have a self-amplification. FIG. 3 schematically depicts the wheel brakes 6 of the wheels of the front axle, which are also referred to as disc brakes 6 below. The self-amplifying wheel brakes 6 of the wheels of the front axle are likewise not limited to the disc brake type. The disc brakes 6 have a mechanical self-amplification device 26 with a wedge mechanism 26: The friction brake lining 21 on one side of the brake disc 22 has a wedge element 27 on its rear surface oriented away from the brake disc 22. By means of the wedge element 27, the friction brake lining 21 rests against an abutting support element 28 that extends obliquely at a wedge angle a in relation to the brake disc 22. The friction brake lining 21 can be moved along the abutting support element 28 in the circumference direction or in a secant direction and at the wedge angle α oblique to the brake disc 22. The mobility of the wedge element 27 along the abutting support element 28 is depicted in the form of roller elements 29, but a slide bearing arrangement is essentially also possible. The abutting support element 28 is supported in the brake caliper 19 in a way that prevents it from moving in the circumference direction of the brake disc 22; the abutting support element 28 is able to move perpendicular to the brake disc 22. The support and movable guidance is depicted in the form of roller elements 30 in FIG. 3, but a slide bearing arrangement is possible here as well. To achieve a self-amplification in the opposite rotation direction of the brake disc, the wedge element 27 and the abutting support element 28 have surfaces that extend at opposite oblique angles, depicted with dashed lines. The wedge element 27 and the abutting support element 28 engage in each other in rib fashion and the opposite, obliquely extending surfaces are situated one behind the other (possibly in several alternations) in the viewing direction and in the radial direction in relation to the brake disc 22. The wedge angles α for the two rotation directions of the brake disc 22 can be the same or different.

For actuation, the self-amplifying disc brake 6 has the same kind of brake piston 20 as conventional disc brakes without self-amplification, which acts on the abutting support element 28 and, via it, on the wedge element 27 with the friction brake lining 21. When the brake piston 20 presses the friction brake lining 21 against the rotating brake disc 22 in order to actuate the disc brake 6, the friction force, which the rotating brake disc 22 exerts on the friction brake lining 21 pressed against it, shifts the friction brake lining 21 together with the wedge element 27 in the rotation direction of the brake disc 22. The support against the abutting support element 28 at the wedge angle α causes an advancing movement of the friction brake lining 21 in relation to the brake disc 22 and a shifting of the brake caliper 19, which is embodied as a floating caliper, transverse to the brake disc, thus causing the other friction brake lining 23 to be pressed against the other side of the brake disc 22, pushing back against the brake piston 20 and displacing hydraulic fluid from a cylinder bore 31 in the brake caliper 19 of the disc brake 6. A brake fluid volume that must be delivered by the brake master cylinder 2 in order to move the brake piston 20 to actuate the disc brake 6 is therefore reduced; a part of the advancing travel is achieved by the travel gain due to the movement of the wedge element 27 along the oblique surface of the abutting support element 28. The disc brake 6 is travel-amplifying. Kinetic energy of the rotating brake disc 22, which is transmitted from the brake disc 22 to the friction brake lining 21 pressed against it during braking, is used as auxiliary energy for actuating the disc brake 6, thus providing a part of the energy required to actuate the disc brake 6. The brake master cylinder 2 only has to provide the remaining part of the actuating energy.

In the circumference direction in relation to the brake disc 22, the friction brake lining 21, or more precisely the wedge element 27, is supported in the brake caliper 19 with return springs 32. The return springs 32 counteract the shifting of the friction brake lining 21 equipped with the wedge element 27 and limit the shifting distance and self-amplification of the disc brake 6.

A rigidity of the brake caliper 19 of the self-amplifying disc brake 6 is greater than a rigidity of the brake caliper 19 of the disc brake 5 without self-amplification; the ratio of the rigidities and spring rates c of the brake calipers 19 can be 4:1, for example. Different spring rates c of the brake calipers 19 of the self-amplifying disc brakes 6 and the disc brakes 5 without self-amplification can be used to influence a pedal force/pedal travel characteristic curve of the vehicle brake system 1. In particular, the spring rates c of the brake calipers 19 are selected so as to approximately produce a pedal force/pedal travel characteristic curve of the familiar kind known from conventional hydraulic vehicle brake systems, which do not have self-amplifying wheel brakes, but often have a (vacuum) brake booster on the brake master cylinder.

For the opposite rotation direction of the brake disc 22, the wedge element 27 and the abutting support element 28 are equipped with the opposite, obliquely extending surfaces. A wear readjustment takes place automatically in the same way as in conventional disc brakes in that when the disc brake 6 is released, the brake piston 20 moves back a certain distance that is determined by an elastic deformation of a piston sealing ring 33. With increasing wear on the friction brake linings 21, 23, the brake piston 20 is no longer moved back into its original starting position with new friction brake linings 21, 23.

A spring rate c of the return springs 32 is selected so that with a maximum brake lining friction coefficient μ between the brake disc 22 and the friction brake lining 21, a clamping travel of the disc brake 6 is zero. The brake lining friction coefficient μ depends on moisture, contamination, and temperature. Its maximum value can be assumed to be approximately 0.45 to 0.6. The requirement that the clamping travel of the disc brake 6 must be zero at the maximum brake lining friction coefficient μ means that at the maximum brake lining friction coefficient μ, the advancing of the friction brake lining 21 as soon as it comes to rest against the rotating brake disc 22, occurs due to its movement in the rotation direction of the brake disc 22 along the oblique surface of the abutting support element 28 and not due to a movement of the brake piston 20. The brake disc 22 is prevented from locking because the return springs 32 counteract a further shifting of the friction brake lining 21 and a resulting increase in the braking force. The intensity of the braking force is determined by the hydraulic pressure in the cylinder bore 31.

Since the self-amplifying disc brakes 6 communicate with the disc brakes 5 without self-amplification, the self-amplification of the self-amplifying disc brakes 6 has an effect on the disc brakes 5 without self-amplification. For this reason, not all of the wheel brakes 5, 6 have to be embodied as self-amplifying. The self-amplifying action makes it possible to eliminate a brake booster; a force conversion ratio is produced due to the ratio of the piston areas in the brake master cylinder 2 and of the brake pistons 20 of the disc brakes 5, 6 and, because of the self-amplifying action, this ratio can be selected to be high in order to achieve a powerful braking force.

According to the invention, when a brake lining friction coefficient μ is high, the braking force of the wheel brakes 5, 6 is reduced. This is achieved by opening the intake valves 13 through which a part of the brake fluid, which is displaced from the brake master cylinder 2 upon brake actuation, flows into the hydraulic reservoirs 14 or the additional hydraulic reservoirs 34. The wheel brake pressure can also be reduced by opening the brake pressure-reducing valves 10 and/or by switching on the hydraulic pumps 11. The above-mentioned measures, which can be carried out individually or jointly in any combination, produce a change in the pedal force/pedal travel characteristic curve of the vehicle brake system 1 when a change occurs in the brake lining friction coefficient μ. In other words, the dependence of the pedal force/pedal travel characteristic curve on a change in the brake lining friction coefficient μ is reduced in the same way as the repercussions on an actuating force of the brake pedal 18. The dependency of the pedal force, which is required to achieve a certain braking force, on a fluctuating brake lining friction coefficient μ is reduced. It is not necessary to determine the brake lining friction coefficient μ in order to carry out pedal force control or regulation. The pedal force/pedal travel characteristic curve can be determined using the pressure sensor 16 and the pedal-travel sensor 17 and can be adapted to a desired characteristic curve by means of the measures described above.

1-13. (canceled)

14. A hydraulic vehicle brake system, comprising:
self-amplifying hydraulic wheel brakes on wheels of one axle of a vehicle; and
hydraulic wheel brakes without self-amplification on wheels of another axle of the vehicle.

15. The vehicle brake system as recited in claim 14, wherein the vehicle brake system has the self-amplifying hydraulic wheel brakes on wheels of a front axle of the vehicle and the hydraulic wheel brakes without self-amplification on wheels of a rear axle of the vehicle.

16. The vehicle brake system as recited in claim 14, wherein the self-amplifying wheel brakes have a different spring rate than the wheel brakes without self-amplification.

17. The vehicle brake system as recited in claim 15, wherein the self amplifying wheel brakes have a different spring rate than the wheel brakes without self-amplification.

18. The vehicle brake system as recited in claim 16, wherein the self-amplifying wheel brakes have a higher spring rate than the wheel brakes without self-amplification.

19. The vehicle brake system as recited in claim 17, wherein the self-amplifying wheel brakes have a higher spring rate than the wheel brakes without self-amplification.

20. The vehicle brake system as recited in claim 16, wherein a ratio of the spring rate of the self-amplifying wheel brakes to that of the wheel brakes without self-amplification is approximately 1:4.

21. The vehicle brake system as recited in claim 17, wherein a ratio of the spring rate of the self-amplifying wheel brakes to that of the wheel brakes without self-amplification is approximately 1:4.

22. The vehicle brake system as recited in claim 14, wherein the vehicle brake system has no brake boosters.

23. The vehicle brake system as recited in claim 14, wherein the self-amplifying wheel brakes have a mechanical self-amplification device with a wedge mechanism.

24. The vehicle brake system as recited in claim 21, wherein the self-amplifying wheel brakes have a mechanical self-amplification device with a wedge mechanism.

25. The vehicle brake system as recited in claim 15, wherein the self-amplifying wheel brakes have a return spring that counteracts an increase in a braking force.

26. The vehicle brake system as recited in claim 24, wherein the self-amplifying wheel brakes have a return spring that counteracts an increase in a braking force.

27. The vehicle brake system as recited in claim 14, wherein the self-amplifying wheel brakes are travel-amplifying.

28. The vehicle brake system as recited in claim 25, wherein a spring rate of the return springs is high enough that with a maximum brake lining friction coefficient, a clamping travel of the wheel brake is approximately zero.

29. The vehicle brake system as recited in claim 26, wherein a spring rate of the return springs is high enough that with a maximum brake lining friction coefficient, a clamping travel of the wheel brake is approximately zero.

30. A method for operating a hydraulic vehicle brake system with hydraulic wheel brakes, comprising conveying brake fluid into a hydraulic reservoir in a valve-controlled fashion, at high brake lining friction coefficients.

31. The method for operating a hydraulic vehicle brake system as recited in claim 30, wherein the hydraulic wheel brakes of the wheels of one axle of a vehicle are self-amplifying and the hydraulic wheel brakes of the wheels of another axle of the vehicle have no self-amplification.

32. The method as recited in claim 30, wherein influence is exerted on a pedal force/pedal travel characteristic curve of the vehicle brake system by conveying brake fluid into hydraulic reservoirs in a valve-controlled way.

33. The method as recited in claim 31, wherein influence is exerted on a pedal force/pedal travel characteristic curve of the vehicle brake system by conveying brake fluid into hydraulic reservoirs in a valve-controlled way.
